(19) United States
(12) Patent Application Publication
(10) Pub. No.: US 2025/0107953 A1
(43) Pub. Date: Apr. 3, 2025

(54) HALO GRAVITY TRACTION APPARATUS WITH ADJUSTABLE BIASING MECHANISM

(71) Applicant: X-Med AB, Västerås (SE)

(72) Inventor: Rune WALLNER, Västerås (SE)

(21) Appl. No.: 18/900,710

(22) Filed: Sep. 28, 2024

(30) Foreign Application Priority Data
Oct. 3, 2023 (EP) 23201410.0

(51) Int. Cl. A61H 1/02

(52) U.S. Cl. CPC A61H 1/0229

(57) ABSTRACT

A halo gravity traction apparatus includes a frame structure, a wire with a first end and a second end, a halo ring connector at the first end of the wire, and a biasing mechanism configured to apply a downward pulling force to the wire at the second end of the wire. The frame structure is configured to support the wire and the biasing mechanism. The apparatus provides a compact and adjustable solution for applying traction to a patient's head and neck, suitable for hospital or home use. Optional choice of using spring loaded and/or free weights makes the apparatus suitable for various patient needs.

### RELATED APPLICATION DATA

This application claims priority to European Patent Application No. 23201410.0, filed Oct. 3, 2023, the disclosure of which is incorporated herein by reference in its entirety.

### FIELD

The technology relates to the field of medical devices, specifically to orthopedic and spinal treatment apparatuses designed to provide traction and support for patients suffering from spinal injuries, deformities, or conditions that require stabilization and alignment of the spine, particularly in preparation for surgery.

### BACKGROUND

Scoliosis is a medical condition characterized by an abnormal curvature of the spine, which can lead to various health issues, including pain, reduced mobility, and impaired heart and lung function. In severe cases, surgical intervention may be necessary to correct the spinal deformity and alleviate the associated symptoms. One pre-surgical treatment option for patients with severe scoliosis is halo-gravity traction, which involves the gradual stretching of the spine to achieve a straighter position before undergoing spinal fusion surgery.

Halo-gravity traction devices have been used for several years to treat severe scoliosis. However, no commercial system is currently available, and all systems have been manufactured in-house by individual hospitals. These in-house manufactured systems typically employ either free weight or spring-loaded traction systems to apply the necessary pulling force to the patient's spine. Each of these systems has its own advantages and disadvantages, and the optimal choice of traction system may vary depending on the patient's specific needs and circumstances.

Free weight traction systems provide a static pulling force, which can be advantageous in certain situations, such as when the patient wants to sit down while using the device. However, free weights can also cause jerking motions and pendulum-like movements, which can be uncomfortable and unpleasant for the patient. On the other hand, spring-loaded traction systems offer a dynamic pulling force, which can eliminate the jerking and pendulum motions associated with free weights. However, the force applied by a spring-loaded system automatically increases when the patient sits down, which can be problematic for young or vulnerable patients who may inadvertently injure themselves due to the sudden increase in force.

In addition to the limitations associated with the choice of traction system, current in-house manufactured halo-gravity traction devices are often too cumbersome and bulky for use in home environments. As a result, patients undergoing halo-gravity traction treatment are typically required to remain in the hospital for extended periods, which can be both inconvenient and costly.

There is a need for a halo-gravity traction apparatus that allows for optimal treatment approach to be employed for each individual patient.

### SUMMARY

The proposed solution comprises a halo gravity traction apparatus. Some aspects and embodiments of the proposed solution are set out in the appended claims and in the description below.

According to a first aspect of the disclosure, a halo gravity traction apparatus comprises a frame structure, a wire having a first end and a second end, a halo ring connector at the first end of the wire, and a biasing mechanism configured to apply a downward pulling force to the wire at the second end of the wire. The frame structure is configured to support the wire and the biasing mechanism. This aspect provides the advantage of a compact configuration of the halo gravity traction apparatus.

Optionally in some examples, the biasing mechanism is configured to selectively apply spring-loaded traction or free weight traction. This provides the advantage of allowing for optimal technique selection based on individual patient needs.

Optionally in some examples, the biasing mechanism comprises a connector member at the second end of the wire, connectable to apply spring-loaded traction or free weight traction to the wire. This provides the advantage of a versatile and easily adjustable connection for varying traction techniques.

Optionally in some examples, the second end of the wire comprises a handle, and the connector member comprises a rope lock for securing the wire at a desired tension. This provides the advantage of easy and secure tension adjustments for the wire.

Optionally in some examples, the biasing mechanism comprises a casing attached to the frame structure and having an aperture at an upper wall of the casing, and a spring device configured in the casing, connectable to the wire through the aperture. This provides the advantage of a compact and protected biasing mechanism.

Optionally in some examples, the spring device comprises at least one spring, a spring connector connected to the at least one spring, and an attachment member extending from the spring connector through the aperture in the casing for connection to the wire. This provides the advantage of a secure and protected connection between the spring device and the wire.

Optionally in some examples, the apparatus further comprises a tension indicator on the spring device and a tension scale on the casing to indicate the applied traction force. This provides the advantage of easy monitoring of the traction force applied to the patient.

Optionally in some examples, the frame structure comprises a plurality of vertical posts, a horizontal bar connecting the vertical posts, an overhead beam extending from the horizontal bar, and a base for supporting the vertical posts. This provides the advantage of a sturdy and supportive frame structure for the apparatus.

Optionally in some examples, the biasing mechanism is attached to the frame structure at a low attachment point, such that the wire runs upwards from the biasing mechanism and is guided along the frame structure. This provides the advantage of a compact design suitable for home use.

Optionally in some examples, the low attachment point is below a height of 100 cm from the ground level of the frame structure. This provides the advantage of a lower profile design for the apparatus.

Optionally in some examples, the wire is guided by wheels at the frame structure such that the halo ring connector is suspended from the overhead beam. This provides the advantage of smooth and efficient wire guidance along the frame structure.

Optionally in some examples, the apparatus is configured as a walker, with the base comprising a plurality of horizontal base bars, a horizontal front beam, and at least three wheels. At least one rear pair of wheels may be configured to rotate and be able to be locked in position. This provides the advantage of a mobile and easily maneuverable apparatus for patients.

Optionally in some examples, the casing is attached to the horizontal front beam. This provides the advantage of a convenient and accessible location for the biasing mechanism, while maintaining a low overall profile of the apparatus.

Optionally in some examples, the base comprises a wheelchair, supporting the vertical posts. This provides the advantage of a comfortable and mobile apparatus for patients with limited mobility.

Optionally in some examples, the casing is attached to the vertical posts behind a backrest of the wheelchair. This provides the advantage of a discreet and unobtrusive placement of the biasing mechanism.

### BRIEF DESCRIPTION OF THE DRAWINGS

Examples are described in more detail below with reference to the appended drawings.

FIG. 1 is a side view of the halo traction apparatus configured as a walker, with a patient further indicated.

FIG. 2 is a front view of the apparatus.

FIG. 3 is a side view of the halo traction apparatus configured with a wheelchair.

FIG. 4 is a cross-section view of the biasing mechanism comprised in the halo traction apparatus, showing a relaxed spring device.

FIG. 5 is a cross-section view of the biasing mechanism comprised in the halo traction apparatus, showing a tensioned spring device.

FIG. 6 is a front view of the biasing mechanism comprised in the halo traction apparatus, showing a load indicator configured with the spring device.

FIG. 7 is a connector member comprising a rope lock, further configured for selectable connection to the spring device or to free weights and for securing application of tension.

### DETAILED DESCRIPTION

The detailed description set forth below provides information and examples of the disclosed technology with sufficient detail to enable those skilled in the art to practice the disclosure.

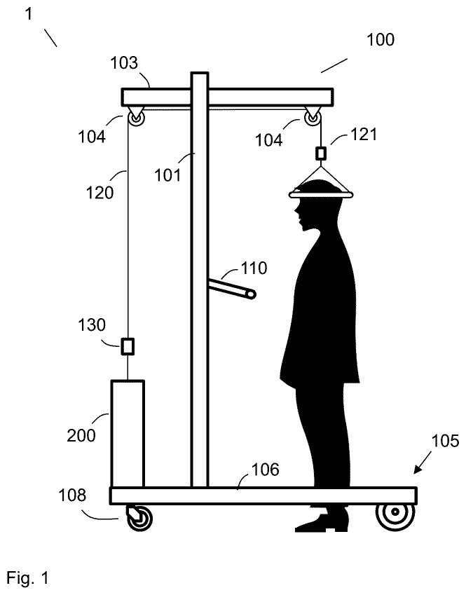

FIG. 1 shows a side view of the halo traction apparatus 1 configured as a walker, with a patient further indicated. The apparatus includes a frame structure 100 with vertical posts 101, a horizontal bar 102, an overhead beam 103, and a base 105 adjacent to ground level with horizontal base bars 106, a horizontal front beam 107, and wheels 108. The base 105 may comprise at least three wheels, such as one front wheel attached to the front beam 7 and two rear wheels attached at one horizontal bar 106 each. In another example, as shown in FIG. 1, a front pair of wheels are included. The front wheel(s) may be configured to rotate in the horizontal plane for maneuverability. The rear pair of wheels may either be fixed to an axis, or optionally also be configured to rotate in the horizontal plane. In the latter case, the rear pair of wheels may selectively be locked in position. The biasing mechanism 200 is attached to the horizontal front beam 107 and includes a casing 201 and a spring device 210 inside the casing. A handlebar 110, which may be adjustable in height and/or extension, may be attached to the vertical posts 101 to allow the patient to comfortably push the walker.

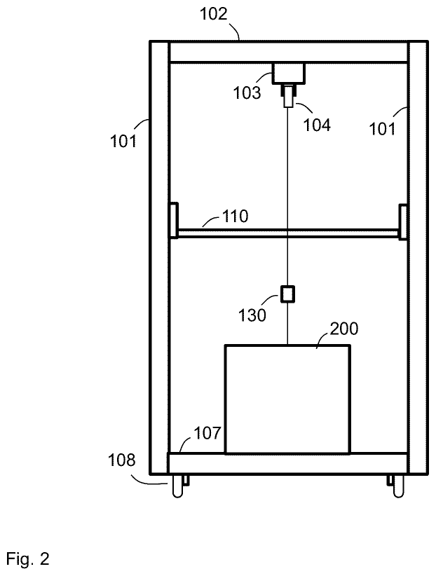

FIG. 2 shows a front view of the apparatus 1, displaying the pair of vertical/upright posts 101 connected by the horizontal bar 102. The overhead beam 103 extends from the horizontal bar 102, and the wire 120 is guided by wheels 104 at the frame structure 100 such that the halo ring connector 121 is suspended from the overhead beam 103 at the intended position of the patient.

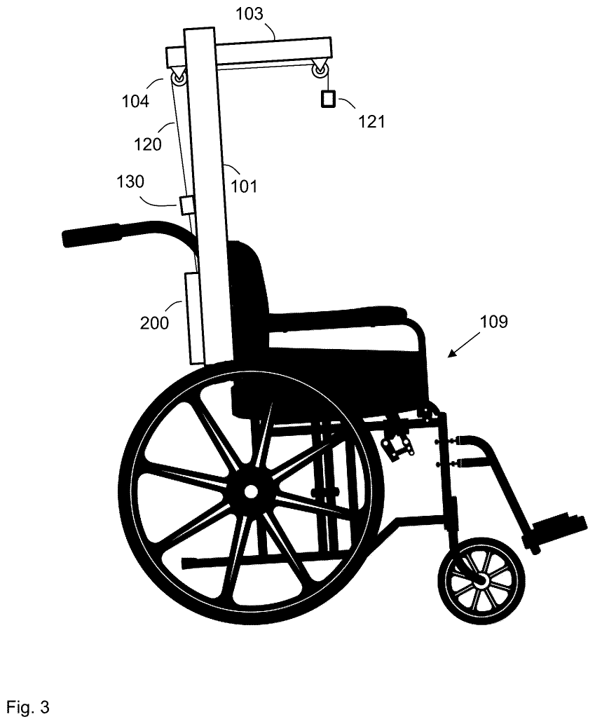

FIG. 3 shows a side view of the halo traction apparatus 1 configured with a wheelchair 109 as the base 105, supporting the vertical posts 101. The casing 201 of the biasing mechanism 200 is attached to the vertical posts behind the backrest of the wheelchair. The casing 201 may otherwise have the same configuration as in the walker embodiment.

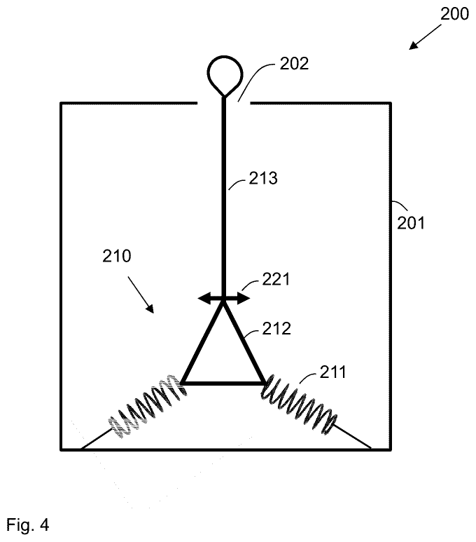

FIG. 4 shows a cross-section view of the biasing mechanism 200 comprised in the halo traction apparatus 1, displaying a relaxed state of a spring device 210 inside the casing 201. The spring device 210 includes at least one spring 211, a spring connector 212, and an attachment member 213 extending from the spring connector 212 through an aperture 202 in the casing 201 for connection to the wire 120.

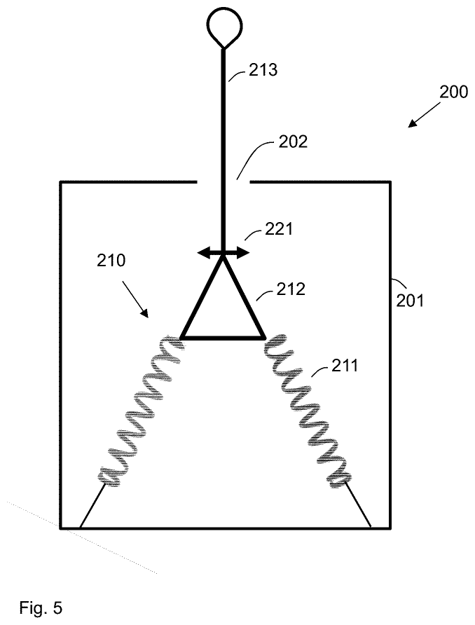

FIG. 5 shows a cross-section view of the biasing mechanism 200 comprised in the halo traction apparatus 1, displaying a tensioned state of the spring device 210 inside the casing 201. The attachment member 213 extends from the spring connector 212 through the aperture 202 in the casing 201 for connection to the wire 120.

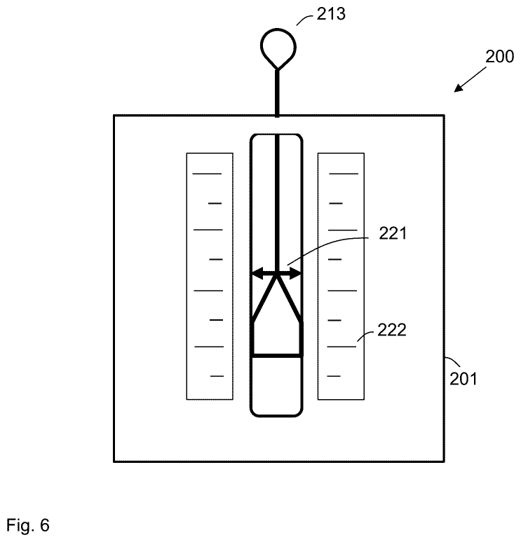

FIG. 6 shows a front view of the biasing mechanism 200 comprised in the halo traction apparatus 1, displaying a tension indicator 221 on the spring device 210 and a tension scale 222 on the casing 201 to indicate the applied traction force.

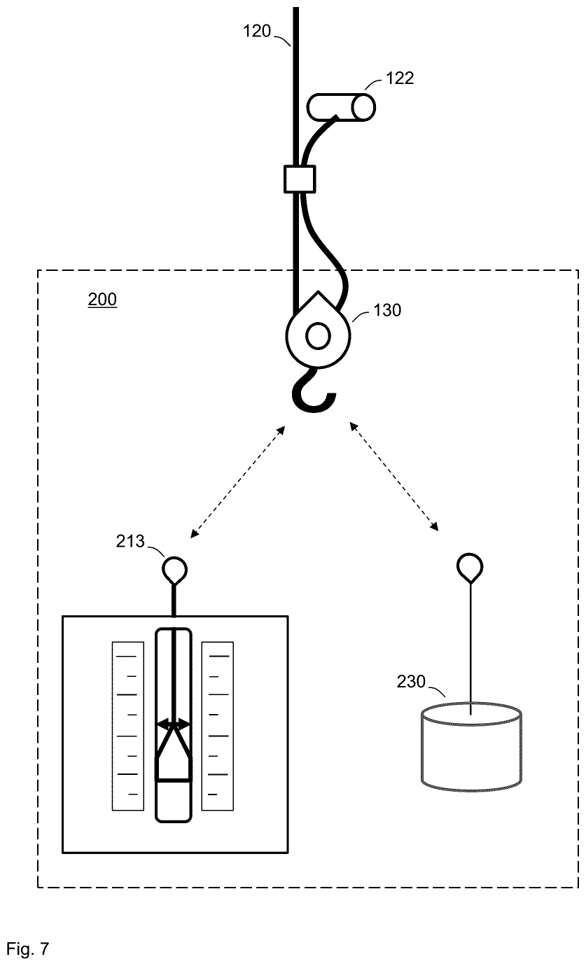

FIG. 7 shows a connector member 130 of the biasing mechanism 200, comprising a rope lock for securing the wire 120 at a desired tension. The connector member 130 is further configured for selectable connection to the spring device 210 or to free weights 230, allowing for the application of either spring-loaded traction or free weight traction.

The frame structure 100 of the halo gravity traction apparatus 1 serves as the primary support system for the apparatus, providing stability and structural integrity. The frame structure 100 is designed to accommodate various components, such as the wire 120, the biasing mechanism 200, and the halo ring connector 121, which are for the proper functioning of the apparatus.

In one example, the frame structure 100 comprises a plurality, such as a pair, of vertical posts 101 that extend upward from the base 105 of the apparatus. These vertical posts 101 may be made of a lightweight and durable material, such as aluminum, to ensure the apparatus is easy to maneuver and transport while maintaining its structural integrity. The vertical posts 101 may be connected to each other by a horizontal bar 102, which provides additional support and stability to the frame structure 100.

The vertical posts 101 and the horizontal bar 102 may be made of the same material, such as aluminum, to ensure uniformity and compatibility in the frame structure 100. The connection between the vertical posts 101 and the horizontal bar 102 may be achieved through various methods, such as welding, bolting, or using brackets, to ensure a secure and stable connection.

In some examples, the frame structure 100 further comprises an overhead beam 103 that extends from the horizontal bar 102. The overhead beam may extend forward in a general direction of use of the apparatus 1. The overhead beam 103 serves as a support for the wire 120 and the halo ring connector 121, allowing the apparatus to apply the necessary traction force to the patient's head. The wire 120 may be guided along the frame structure 100 by a set of wheels or rollers 104 that are strategically positioned to ensure smooth and controlled movement of the wire 120 and the halo ring connector 121. In some examples, the overhead beam 103 may be hollow, and be configured to internally guide the wire 120. This way, the risk of entanglement of the wire is further reduced.

The suspension of the halo ring connector 121 from the overhead beam 103 allows for precise control of the traction force applied to the patient's head. This configuration ensures that the traction force is evenly distributed across the patient's head, minimizing the risk of injury or discomfort. The wheels 104 that guide the wire 120 along the frame structure 100 further contribute to the smooth and controlled movement of the halo ring connector 121, ensuring optimal traction force application.

The base 105 of the frame structure 100 provides support and stability to the apparatus, ensuring that the apparatus can be moved by the user, either the patient or a caregiver, while securely providing intended traction during use. The base 105 may comprise various configurations, such as a walker base with horizontal bars 106 and a front beam 107, or a wheelchair base 109 that supports the vertical posts 101.

In one example, the base 105 of the frame structure 100 comprises a plurality of horizontal base bars 106 and a horizontal front beam 107, forming a rectangular shape with an open back end. This configuration provides a stable and secure foundation for the apparatus, ensuring that it remains in place during use. The horizontal base bars 106 and the horizontal front beam 107 may be made of the same material as the vertical posts 101 and the horizontal bar 102, such as aluminum, to ensure uniformity and compatibility in the frame structure 100. The base 105 may comprise further cross beams in addition to the front beam 107.

In some examples, the base 105 of the frame structure 100 comprises a wheelchair 109 that supports the vertical posts 101. This configuration allows for increased mobility and versatility in the use of the apparatus, as it can be easily maneuvered and transported by the patient or a caregiver. The attachment of the vertical posts 101 to the wheelchair 109 may be achieved through various methods, such as brackets or clamps, to ensure a secure and stable connection.

The frame structure 100 and its various components provide a stable and secure foundation for the halo gravity traction apparatus 1, ensuring that it remains in place during use and effectively applies the necessary traction force to the patient's head. The use of lightweight and durable materials, such as aluminum, in the construction of the frame structure 100 ensures that the apparatus is easy to maneuver and transport while maintaining its structural integrity. The various configurations of the base 105, such as a walker base or a wheelchair base, provide increased versatility and mobility in the use of the apparatus, allowing it to be easily adapted to the individual needs of the patient.

The halo gravity traction apparatus 1 comprises a wire 120 and a halo ring connector 121 that play a role in providing traction to the patient. The wire 120 has a first end and a second end, with the halo ring connector 121 being attached to the first end of the wire. The wire 120 is designed to be strong, durable, and capable of withstanding the forces applied during traction therapy. In some examples, the wire 120 may be a rope, or be made of materials such as steel, stainless steel, or other suitable materials that provide the necessary strength and durability.

The first end of the wire 120 is connected to the halo ring connector 121, which is designed to securely attach to a halo ring worn by the patient. The halo ring connector 121 may comprise various mechanisms for secure attachment, such as hooks, clasps, or other suitable connectors. In some examples, the halo ring connector 121 may be adjustable to accommodate different sizes and shapes of halo rings, ensuring a secure and comfortable fit for the patient.

The second end of the wire 120 is connected to the biasing mechanism 200, which applies a downward pulling force to the wire 120 to provide traction to the patient. In some examples, the second end of the wire 120 may comprise a handle 122 that allows for easy adjustment of the tension in the wire 120 by the patient or a caregiver. The handle 122 may be ergonomically designed for comfortable and secure gripping, and may be made of materials such as plastic, rubber, or other suitable materials that provide a comfortable grip.

In some examples, the second end of the wire 120 may be connected to or comprise a connector member 130 that allows for the selective application of spring- loaded traction or free weight traction. This is conveniently achieved by configuring the biasing mechanism 200 to apply a downward pulling force to the wire 120, wherein gravity-based traction can easily be selected instead of spring-based traction. This allows for improved opportunity to configure the apparatus for a suitable treatment approach to be employed for each individual patient, and/or at different occasions for a certain patient.

The connector member 130 may comprise a rope lock mechanism that securely holds the wire 120 at a desired tension, allowing for easy adjustment of the traction force applied to the patient. The rope lock mechanism may comprise various components, such as clamps, ratchets, or other suitable devices that securely hold the wire 120 in place while allowing for easy adjustment of the tension. The rope lock may further comprise a button for releasing engagement of the wire 120.

The ability to selectively apply spring-loaded traction or free weight traction provides several advantages for the patient and caregiver. Spring-loaded traction may be more suitable for patients who require a more constant and controlled traction force, while free weight traction may be more appropriate for patients who require a more variable and dynamic traction force. The ability to easily switch between these two modes of traction allows for the optimal technique to be used for each individual patient's needs, ensuring the most effective and comfortable treatment possible.

In some examples, the apparatus 1 may comprise additional optional features to further enhance the functionality and usability of the wire 120 and halo ring connector 121. For example, the wire 120 may comprise markings or indicators to show the length of the wire 120 or the amount of tension applied, allowing for easy monitoring and adjustment of the traction force. Additionally, the halo ring connector 121 may comprise safety features, such as a quick-release mechanism, to allow for the rapid detachment of the halo ring connector 121 from the halo ring in case of an emergency. (The halo ring is, as such, not part of the apparatus 1).

Overall, the wire 120 and halo ring connector 121 are components of the halo gravity traction apparatus 1, providing the necessary connection between the patient's halo ring and the biasing mechanism 200 to apply the desired traction force. The various features and options described above allow for a customizable and adaptable system that can be tailored to the specific needs and preferences of each individual patient, ensuring the most effective and comfortable treatment possible.

The biasing mechanism 200 comprised in the halo gravity traction apparatus 1 is designed to apply a downward pulling force to the wire 120 at the second end of the wire. The casing may be attached to the frame structure 100, such as by screws or clamps. The biasing mechanism 200 provides the user with the ability to selectively apply spring-loaded traction or free weight traction, allowing for optimal technique based on individual patient needs. By configuring the biasing mechanism 200 to apply a downward pulling force to the wire 120 allows for placing the biasing mechanism at a low point on the frame structure 100. This way, overall height of the apparatus 1 may be reduced. This provides a more compact and user-friendly apparatus that can be used in home settings, reducing the need for lengthy hospital stays and associated costs.

In one example, the biasing mechanism 200 includes a casing 201 that is attached to the frame structure 100. The casing 201 may be made of a durable material, such as metal or plastic, and is designed to house the components of the biasing mechanism 200. The casing 201 features an aperture 202 at its upper wall, which allows for the connection of the spring device 210 to the wire 120.

The casing may comprise a substantially closed box, such as fully closed apart from the aperture configured for the attachment member 130 to the spring connector. The substantially closed box minimizes the risk for tampering or unintentional interference with the biasing mechanism 200, and the risk for unintentionally getting dirty or injured by the spring device 210, and the risk for the spring device 210 getting caught in clothing, blankets etc.

The spring device 210 is configured within the casing 201 and is designed to apply a downward pulling force to the wire 120 through the aperture 202. In some examples, the spring device 210 comprises one or more springs 211, which may be helical springs or other types of springs suitable for providing the desired traction force. Each spring 211 may be fixed, at one end of the spring 211, with respect to the frame structure 100, such as attached at a bottom portion of the casing 201. An opposing (upper) end of each spring 211 is attached to a spring connector 212, which allows for the attachment of the springs 211 to the wire 120. In some examples, the spring device 210 comprises two springs 211, wherein the two springs 211 and the spring connector creates 212 the shape of a triangle. This construction makes the optimal use of the dynamics of the two springs 211.

The spring device 210 further comprises an attachment member 213 that extends from the spring connector 212 through the aperture 202 in the casing 201. The attachment member 213 may end in a loop or hook 214 for easy connection to the wire 120. This configuration allows for the application of spring-loaded traction to the wire 120 and provides a secure and adjustable connection between the spring device 210 and the wire 120. The attachment member 213 may be integral with the spring connector 212 or may in other examples comprise a rod or wire attached to the spring connector 212.

In some examples, the spring device 210 includes a tension indicator 221 that provides a visual indication of the applied traction force. The tension indicator 221 may be a mechanical or electronic device that measures the tension in the springs 211 and displays the corresponding force. Additionally, a tension scale 222 may be provided on the casing 201 to allow for easy reading of the applied traction force. This feature enables the user to monitor and adjust the traction force as needed for optimal treatment. In some examples, the tension indicator 221 may be attached to the spring connector 212, wherein the tension scale 222 is provided on a front wall of the casing 201. The tension indicator 221 is configured to be visible at the front wall/panel, either through an opening slit or through a window of the casing as shown in FIG. 6, or by the front panel of the casing being entirely transparent. The tension scale 222 may indicate force or correlating weight in a unit of choice, such as kg, pounds, or other. This provides a safe and easy way of ensuring that correct tension is applied to the wire.

The biasing mechanism 200 may be configured to selectively apply spring-loaded traction or free weight traction to the wire 120. In one example, a connector member 130 is provided at the second end of the wire, which can be connected to either the spring device 210 for spring-loaded traction or to free weights 230 for free weight traction. This feature allows the user, caregiver or physician to choose the most appropriate traction method for their specific needs and preferences.

In some examples, as shown in FIG. 7, the second end of the wire 120 comprises a handle 122, and the connector member 130 includes a rope lock for securing the wire 120 at a desired tension. This configuration allows for easy adjustment of the traction force and ensures that the wire 120 remains securely in place during use. The rope lock of the connector member 130 may be connectable to the attachment member 213 of the spring device 210, above the casing 201, e.g., by means of a shackle, hook, carabiner, or the like which is configured to connect to the attachment member 103.

By providing a biasing mechanism 200 with selectable spring-loaded traction or free weight traction options, the halo gravity traction apparatus 1 offers a versatile and customizable solution for patients requiring halo traction therapy. This adaptability allows for tailored treatment plans and improved patient outcomes.

The halo gravity traction apparatus 1 features a low attachment point for the biasing mechanism 200, which provides several advantages in terms of compactness and ease of use. In one example, the low attachment point is positioned below a height of 100 cm from the ground level of the frame structure 100. In some examples, the low attachment point may be positioned below a height of 120 cm from the ground level. The low positioning of the biasing mechanism 200, including the casing 201, results in a comparatively low overall construction, compared to prior art devices, and makes it possible to enter through a regular sized doorframe. In this context, the overall height of the apparatus 1 may in some embodiments be less than 210 cm, less than 205 cm, or less than 200 cm. This is important for patients that can undergo the treatment in their homes instead of hospital. The casing may be placed below a height of less than 120 cm from ground level, such as below 100 cm. The low attachment point allows for a more compact design, making the apparatus suitable for home use and easier to transport and store.

In one example, the biasing mechanism 200 is attached to the frame structure 100 at the low attachment point. The attachment can be made to various components of the frame structure, depending on the specific configuration of the apparatus. For instance, in one example where the apparatus is configured as a walker, the biasing mechanism 200 may be attached to the horizontal front beam 107 of the walker base 105. In another example, where the apparatus is configured with a wheelchair 109 as the base 105, the biasing mechanism 200 may be attached to the vertical posts 101 of the wheelchair frame, behind the backrest.

In one example, the wire 120 runs upwards from the biasing mechanism 200 and is guided along the frame structure 100. This upward orientation of the wire 120 allows for efficient use of space and contributes to the compact design of the apparatus. The wire 120 may be guided by wheels 104 at the frame structure 100 such that the halo ring connector 121 is suspended from the overhead beam 103. This configuration ensures that the wire 120 is properly guided and tensioned, providing optimal traction for the patient.

The low attachment point and wire guidance features of the halo gravity traction apparatus 1 provide a compact and efficient design that is suitable for home use and easy to transport and store. The apparatus may comprise various configurations and optional features, such as a walker base or a wheelchair base, to accommodate the specific needs and preferences of individual patients.

In one example, the halo gravity traction apparatus 1 is configured as a walker, providing support and stability for patients undergoing halo gravity traction therapy. The frame structure 100 in this configuration comprises a base 105 with horizontal base bars 106 and a horizontal front beam 107, which together form a stable and supportive structure for the patient to hold onto and move around with during therapy sessions.

As seen in FIGS. 1 and 2, the walker configuration may comprise an adjustable handlebar 110 connected to the vertical posts 101, allowing for easy maneuvering and control of the apparatus 1 by the patient or a caregiver. The handlebar 110 can be adjusted to suit the individual needs and preferences of the patient, ensuring a comfortable and personalized therapy experience.

The walker configuration may comprise at least one front pair of wheels 108 and at least one rear pair of wheels 108. In some examples, the front pair of wheels 108 are configured to rotate, allowing for smooth and easy movement of the apparatus 1 in various directions. The rear pair of wheels 108, on the other hand, may be locked in position, providing additional stability and preventing unwanted movement of the apparatus 1 during therapy sessions.

The biasing mechanism 200 in the walker configuration may be attached to the horizontal front beam 107 of the base 105, providing a low attachment point for the wire 120 and allowing for a compact design suitable for home use. The wire 120 runs upwards from the biasing mechanism 200 and is guided along the frame structure 100 by wheels 104, ensuring smooth and efficient operation of the apparatus 1.

In another example, the halo gravity traction apparatus 1 is configured with a wheelchair 109 as the base 105, supporting the vertical posts 101 of the frame structure 100. This configuration provides a comfortable and convenient option for patients who require additional support and mobility during halo gravity traction therapy sessions.

In the wheelchair configuration, the casing 201 of the biasing mechanism 200 may be attached to the vertical posts 101 of the frame structure 100, behind the backrest of the wheelchair 109. This positioning of the biasing mechanism 200 provides a low attachment point for the wire 120, contributing to a compact and space-saving design that is suitable for home use.

The wire 120 in the wheelchair configuration runs upwards from the biasing mechanism 200 and is guided along the frame structure 100 by wheels 104, ensuring smooth and efficient operation of the apparatus 1. The wire 120 may be connected to the halo ring connector 121 at its first end, and to the handle 122 and connector member 130 at its second end, allowing for selectable application of spring-loaded traction or free weight traction, depending on the individual needs and preferences of the patient.

In summary, the various configurations and examples of the halo gravity traction apparatus 1 described in this section demonstrate the versatility and adaptability of the disclosure, catering to the diverse needs and preferences of patients undergoing halo gravity traction therapy. The inventive features, such as the low attachment point, selectable traction options, and compact design, provide significant advantages in terms of ease of use, comfort, and convenience, making the apparatus 1 an ideal solution for both clinical and home-based therapy settings.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A halo gravity traction apparatus, comprising:
a frame structure;
a wire having a first end and a second end;
a halo ring connector at the first end of the wire;
a biasing mechanism configured to apply a downward pulling force to the wire at the second end of the wire;
wherein the frame structure is configured to support the wire and the biasing mechanism.

2. The halo gravity traction apparatus according to claim 1, wherein the biasing mechanism is configured to selectively apply spring-loaded traction or free weight traction.

3. The halo gravity traction apparatus according to claim 2, further comprising a connector member at the second end of the wire, connectable to the biasing member.

4. The halo gravity traction apparatus according to claim 3, wherein the connector member comprises a rope lock for securing the wire at a desired tension.

5. The halo gravity traction apparatus according to claim 4, wherein the second end of the wire comprises a handle for pulling the wire when threaded through the rope lock to apply tension.

6. The halo gravity traction apparatus according to claim 1, wherein the biasing mechanism comprises:
a casing attached to the frame structure, said casing having an aperture at an upper wall of the casing;
a spring device configured in the casing, connectable to the wire through the

7. The halo gravity traction apparatus according to claim 6, wherein the spring device comprises:
at least one spring;
a spring connector connected to the at least one spring;
an attachment member extending from the spring connector through the aperture in the casing for connection to the wire.

8. The halo gravity traction apparatus according to claim 7, further comprising a tension indicator on the spring device and a tension scale on the casing to indicate the applied traction force.

9. The halo gravity traction apparatus according to claim 1, wherein the frame structure comprises:
a plurality of vertical posts;
a horizontal bar connecting the vertical posts;
an overhead beam extending from the horizontal bar; and
a base for supporting the vertical posts,
wherein the wire is guided by wheels at the frame structure such that the halo ring connector is suspended from the overhead beam.

10. The halo gravity traction apparatus according to claim 9, configured as a walker, wherein the base comprises:
a plurality of horizontal base bars;
a horizontal front beam;
at least three wheels.

11. The halo gravity traction apparatus according to claim 10, wherein the biasing mechanism comprises:
a casing attached to the attached to the horizontal front beam, said casing having an aperture at an upper wall of the casing;
a spring device configured in the casing, connectable to the wire through the

12. The halo gravity traction apparatus according to claim 9, wherein the base comprises a wheelchair, supporting the vertical posts.

13. The halo gravity traction apparatus according to claim 12, wherein the biasing mechanism comprises:
a casing attached to the attached behind a backrest of the wheelchair, said casing having an aperture at an upper wall of the casing;
a spring device configured in the casing, connectable to the wire through the aperture.

14. The halo gravity traction apparatus according to claim 1, wherein the biasing mechanism is attached to the frame structure at a low attachment point, such that the wire runs upwards from the biasing mechanism and is guided along the frame structure.

15. The halo gravity traction apparatus according to claim 14, wherein the low attachment point is below a height of 100 cm from ground level of the frame structure.
